(19) United States
(12) Patent Application Publication
(10) Pub. No.: US 2002/0053017 A1
(43) Pub. Date: May 2, 2002

(54) Register instructions for a multithreaded processor

(76) Inventors: Matthew J. Adiletta, Worcester, MA (US); Debra Bernstein, Sudbury, MA (US); Donald F. Hooper, Shrewsbury, MA (US); William R. Wheeler, Southborough, MA (US); Gilbert Wolrich, Framingham, MA (US)

Correspondence Address: DENIS G. MALONEY, Fish & Richardson P.C., 225 Franklin Street, Boston, MA, 02110-2804, US

(21) Appl. No.: 09/811,995

(22) Filed: Mar. 19, 2001

Related U.S. Application Data
(63) Continuation of application No. PCT/US00/24054, filed on Sep. 1, 2000.

(51) Int. Cl. G06F 9/00

(52) U.S. Cl. 712/228

(57) ABSTRACT

A method of operating a processor including loading one or more bytes of data within a register associated with microengines with a shifted value of an operand and preserving or clearing the bytes of data that are not loaded. The method further includes providing a bit mask that specifies which of the one or more bytes of data within the register are affected.

### PRIORITY CLAIM UNDER 35 U.S.C. §120

This application is a continuation application of and claims priority to PCT Application Serial No. PCT/USOO/24054 filed on Sep. 1, 2000.

### BACKGROUND

This invention relates to a computer instruction for a computer processor, and more specifically a local register instruction associated with a microengine.

Parallel processing is an efficient form of information processing of concurrent events in a computing process. Parallel processing demands concurrent execution of many programs in a computer, in contrast to sequential processing. In the context of a parallel processor, parallelism involves doing more than one thing at the same time. Unlike a serial paradigm where all tasks are performed sequentially at a single station or a pipelined machine where tasks are performed at specialized stations, with parallel processing, a number of stations are provided with each capable of performing all tasks. That is, in general all or a number of the stations work simultaneously and independently on the same or common elements of a problem. Certain problems are suitable for solution by applying parallel processing.

### DESCRIPTION OF DRAWINGS

The foregoing features and other aspects of the invention will be described further in detail by the accompanying drawings, in which:

FIG. 1 is a block diagram of a communication system employing a hardware-based multithreaded processor.

FIG. 2 is a detailed block diagram of the hardware-based multithreaded processor of FIG. 1.

FIG. 3 is a block diagram of a micro engine functional unit employed in the hardware-based multithreaded processor of FIGS. 1 and 2.

FIG. 4 is a block diagram of a pipeline in the micro engine of FIG. 3.

FIG. 5 is a block diagram illustrating a format for arithmetic logic unit (ALU) instruction set.

### DETAILED DESCRIPTION

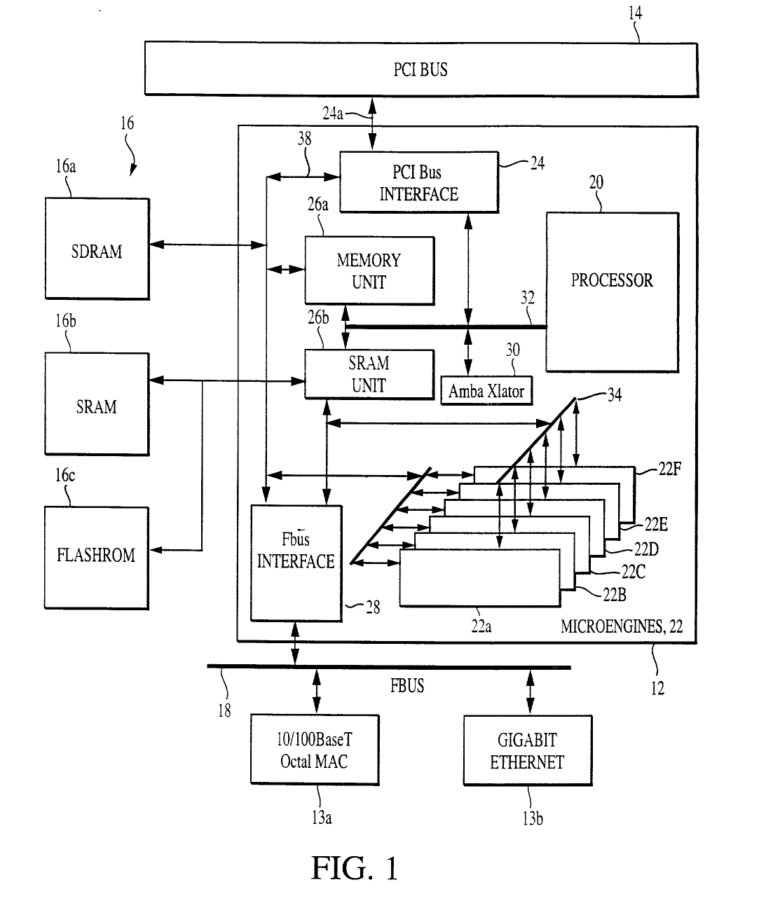

Referring to FIG. 1, a communication system 10 includes a parallel, hardware-based multithreaded processor 12. The hardware-based multithreaded processor 12 is coupled to a bus such as a PCI bus 14, a memory system 16 and a second bus 18. The system 10 is especially useful for tasks that can be broken into parallel subtasks or functions. Specifically, hardware-based multithreaded processor 12 is useful for tasks that are bandwidth oriented rather than latency oriented. The hardware-based multithreaded processor 12 has multiple micro engines 22 each with multiple hardware controlled threads that can be simultaneously active and independently work on a task.

The hardware-based multithreaded processor 12 also includes a central controller 20 that assists in loading micro code control for other resources of the hardware-based multithreaded processor 12 and performs other general purpose computer type functions such as handling protocols, exceptions, extra support for packet processing where the micro engines 22 pass the packets off for more detailed processing such as in boundary conditions. In one embodiment, the processor 20 is a Strong Arm® (Arm is a trademark of ARM Limited, United Kingdom) based architecture. The general-purpose microprocessor 20 has an operating system. Through the operating system the processor 20 can call functions to operate on micro engines 22a-22f. The processor 20 can use any supported operating system, preferably a real time operating system. For the core processor 20 implemented as Strong Arm architecture, operating systems such as, Microsoft-NT real-time, VXWorks and μCUS, a freeware operating system available over the Internet, can be used.

Functional micro engines (micro engines) 22a-22f each maintain program counters in hardware and states associated with the program counters. Effectively, a corresponding number of sets of threads can be simultaneously active on each of the micro engines 22a-22f while only one is actually operating at any one time.

In an embodiment, there are six micro engines 22a-22f as shown. Each micro engine 22a-22f has capabilities for processing four hardware threads. The six micro engines 22a-22f operate with shared resources including memory system 16 and bus interfaces 24 and 28. The memory system 16 includes a Synchronous Dynamic Random Access Memory (SDRAM) controller 26a and a Static Random Access Memory (SRAM) controller 26b. SDRAM memory 16a and SDRAM controller 26a are typically used for processing large volumes of data, e.g., processing of network payloads from network packets. The SRAM controller 26b and SRAM memory 16b are used in a networking implementation for low latency, fast access tasks, e.g., accessing look-up tables, memory for the core processor 20, and so forth.

The six micro engines 22a-22f access either the SDRAM 16 a or SRAM 16b based on characteristics of the data. Thus, low latency, low bandwidth data is stored in and fetched from SRAM 16b, whereas higher bandwidth data for which latency is not as important, is stored in and fetched from SDRAM 16a. The micro engines 22a-22f can execute memory reference instructions to either the SDRAM controller 26a or SRAM controller 16b.

Advantages of hardware multithreading can be explained by SRAM or SDRAM memory accesses. As an example, an SRAM access requested by a Thread_0, from a micro engine will cause the SRAM controller 26b to initiate an access to the SRAM memory 16b. The SRAM controller 26b controls arbitration for the SRAM bus, accesses the SRAM 16b , fetches the data from the SRAM 16b , and returns data to a requesting micro engine 22a-22f . During an SRAM access, if the micro engine, e.g., micro engine 22a , had only a single thread that could operate, that micro engine would be dormant until data was returned from the SRAM 16b. By employing hardware context swapping within each of the micro engines 22a-22f , the hardware context swapping enables other contexts with unique program counters to execute in that same micro engine. Thus, another thread, e.g., Thread_1 can function while the first thread, i.e., Thread_0, is awaiting the read data to return. During execution, Thread_1 may access the SDRAM memory 16a. While Thread_operates on the SDRAM unit 16a, and Thread_0 is operating on the SRAM unit 16b , a new thread, e.g., Thread_2 can now operate in the micro engine 22a. Thread_2 can operate for a certain amount of time until it needs to access memory or perform some other long latency operation, such as making an access to a bus interface. Therefore, simultaneously, the processor 12 can have a bus operation, SRAM operation and SDRAM operation all being completed or operated upon by one micro engine 22a and have one more thread available to process more work in the data path.

The hardware context swapping also synchronizes completion of tasks. For example, two threads could hit the same shared resource e.g., SRAM 16b . Each one of these separate functional units, e.g., the FBUS interface 28, the SRAM controller 26a, and the SDRAM controller 26b, when they complete a requested task from one of the micro engine thread contexts reports back a flag signaling completion of an operation. When the micro engine receives the flag, the micro engine can determine which thread to turn on.

An application for the hardware-based multithreaded processor 12 is as a network processor. As a network processor, the hardware-based multithreaded processor 12 interfaces to network devices such as a media access controller device e.g., a 10/100BaseT Octal MAC 13a or a Gigabit Ethernet device 13b. In general, as a network processor, the hardware-based multithreaded processor 12 can interface to any type of communication device or interface that receives/sends large amounts of data. Communication system 10 functioning in a networking application could receive network packets from the devices 13a, 13b and process those packets in a parallel manner. With the hardware-based multithreaded processor 12, each network packet can be independently processed.

Another example for use of processor 12 is a print engine for a postscript processor or as a processor for a storage subsystem, e.g., Redundant Array of Independent Disk (RAID) storage, a category of disk drives that employs two or more drives in combination for fault tolerance and performance. A further use is as a matching engine. In the securities industry for example, the advent of electronic trading requires the use of electronic matching engines to match orders between buyers and sellers. These and other parallel types of tasks can be accomplished utilizing the system 10.

The processor 12 includes the bus interface 28 that couples the processor to the second bus 18. In an embodiment, bus interface 28 couples the processor 12 to the FBUS (FIFO bus) 18. The FBUS interface 28 is responsible for controlling and interfacing the processor 12 to the FBUS 18. The FBUS 18 is a 64-bit wide FIFO bus, used to interface to Media Access Controller (MAC) devices, e.g., 10/100Base T Octal MAC 13a.

The processor 12 includes a second interface e.g., PCI bus interface 24, that couples other system components that reside on the PCI 14 bus to the processor 12. The PCI bus interface 24 provides a high-speed data path 24a to memory 16, e.g., SDRAM memory 16a. Through PCI bus interface 24 data can be moved quickly from the SDRAM 16a through the PCI bus 14, via direct memory access (DMA) transfers. The hardware based multithreaded processor 12 supports image transfers. The hardware based multithreaded processor 12 can employ DMA channels so if one target of a DMA transfer is busy, another one of the DMA channels can take over the PCI bus 14 to deliver information to another target to maintain high processor 12 efficiency. Additionally, the PCI bus interface 24 supports target and master operations. Target operations are operations where slave devices on bus 14 access SDRAMs through reads and writes that are serviced as a slave to a target operation. In master operations, the processor core 20 sends data directly to or receives data directly from the PCI interface 24.

Each of the functional units 22 is coupled to one or more internal buses. As described below, the internal buses are dual, 32 bit buses (i.e., one bus for read and one for write). The hardware-based multithreaded processor 12 also is constructed such that the sum of the bandwidths of the internal buses in the processor 12 exceed the bandwidth of external buses coupled to the processor 12. The processor 12 includes an internal core processor bus 32, e.g., an ASB Advanced System Bus (ASB), that couples the processor core 20 to the memory controller 26a, 26b and to an ASB translator 30, described below. The ASB bus 32 is a subset of the so-called Advanced Microcontroller Bus Architecture (AMBA) bus that is used with the Strong Arm processor core 20. AMBA is an open standard, on-chip bus specification that details a strategy for the interconnection and management of functional blocks that makes up a System-on-chip (SoC). The processor 12 also includes a private bus 34 that couples the micro engine units 22 to SRAM controller 26b , ASB translator 30 and FBUS interface 28. A memory bus 38 couples the memory controller 26a, 26b to the bus interfaces 24 and 28 and memory system 16 including flashrom 16c that is used for boot operations and so forth.

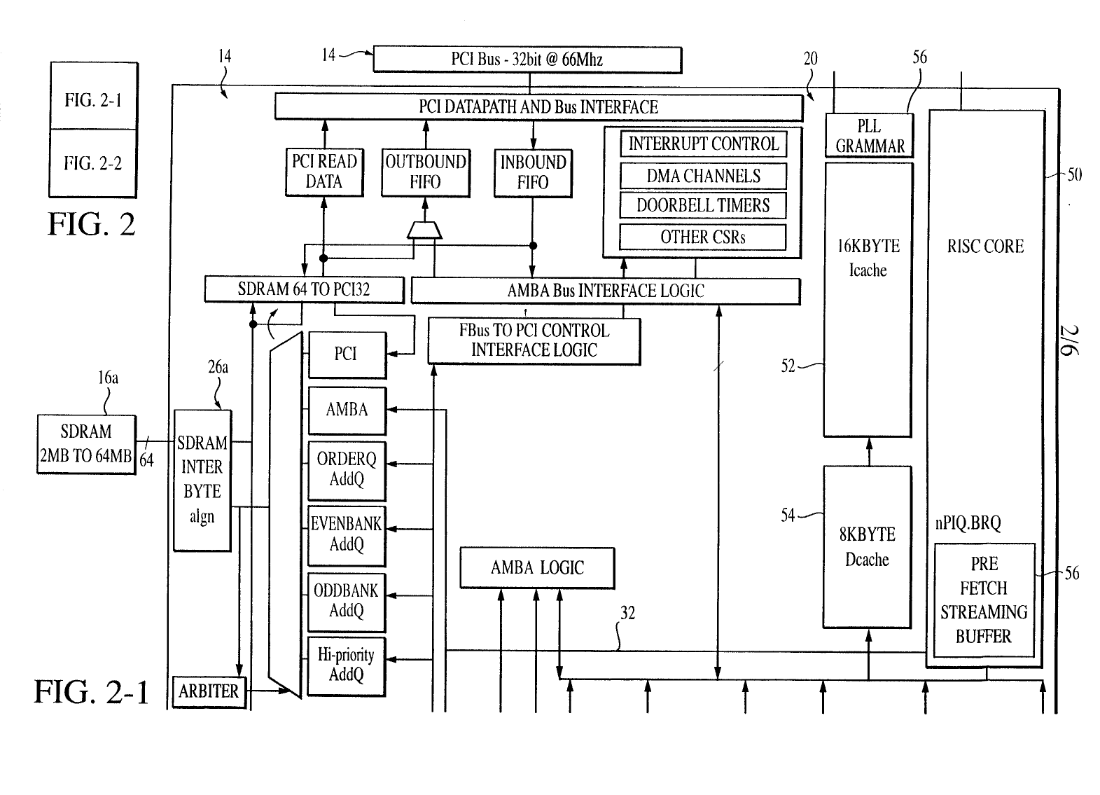

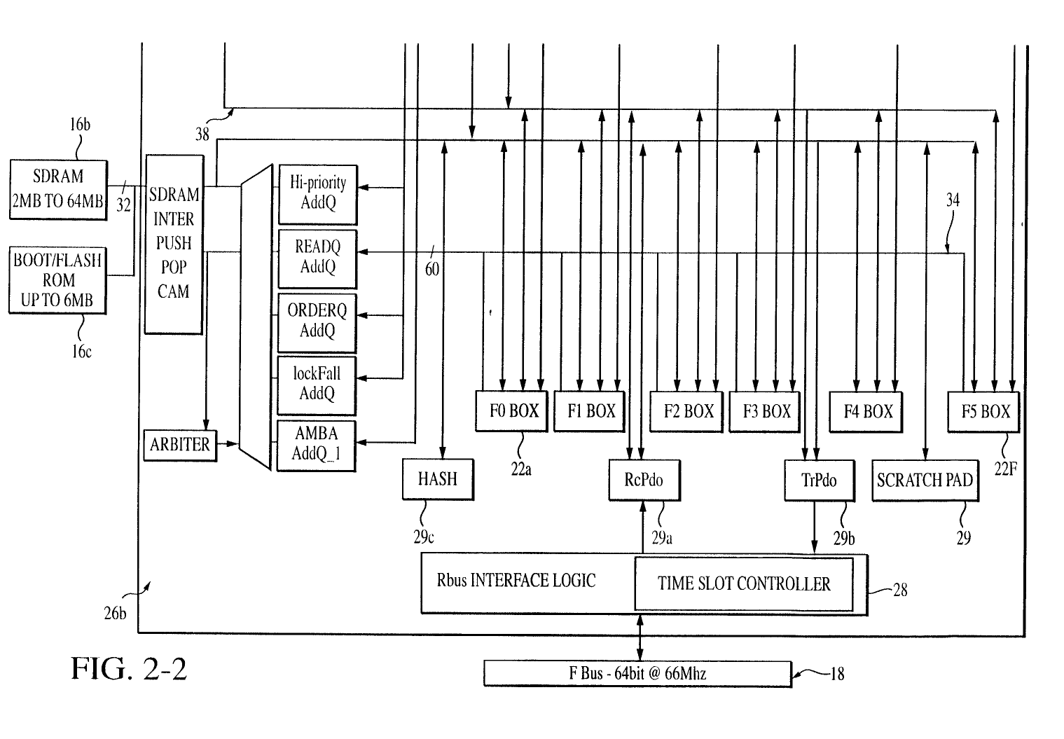

Referring to FIG. 2, each of the micro engines 22a-22f includes an arbiter that examines flags to determine the available threads to be operated upon. Any thread from any of the micro engines 22a-22f can access the SDRAM controller 26a, SDRAM controller 26b or FBUS interface 28. The memory controllers 26a and 26b each include queues to store outstanding memory reference requests. The queues either maintain order of memory references or arrange memory references to optimize memory bandwidth. For example, if a thread_0 has no dependencies or relationship to a thread_1, there is no reason that thread_1 and thread_0 cannot complete their memory references to the SRAM unit 16b out of order. The micro engines 22a-22f issue memory reference requests to the memory controllers 26a and 26b. The micro engines 22a-22f flood the memory subsystems 26aand 26b with enough memory reference operations such that the memory subsystems 26a and 26b become the bottleneck for processor 12 operation.

If the memory subsystem 16 is flooded with memory requests that are independent in nature, the processor 12 can perform memory reference sorting. Memory reference sorting improves achievable memory bandwidth. Memory reference sorting, as described below, reduces dead time or a bubble that occurs with accesses to SRAM 16b. With memory references to SRAM 16b, switching current direction on signal lines between reads and writes produces a bubble or a dead time waiting for current to settle on conductors coupling the SRAM 16b to the SRAM controller 26b.

That is, the drivers that drive current on the bus need to settle out prior to changing states. Thus, repetitive cycles of a read followed by a write can degrade peak bandwidth. Memory reference sorting allows the processor 12 to organize references to memory such that long strings of reads can be followed by long strings of writes. This can be used to minimize dead time in the pipeline to effectively achieve closer to maximum available bandwidth. Reference sorting helps maintain parallel hardware context threads. On the SDRAM 16a, reference sorting allows hiding of pre-charges from one bank to another bank. Specifically, if the memory system 16b is organized into an odd bank and an even bank, while the processor is operating on the odd bank, the memory controller can start pre-charging the even bank. Pre-charging is possible if memory references alternate between odd and even banks. By ordering memory references to alternate accesses to opposite banks, the processor 12 improves SDRAM bandwidth. Additionally, other optimizations can be used. For example, merging optimizations where operations that can be merged, are merged prior to memory access, open page optimizations where by examining addresses an opened page of memory is not reopened, chaining, as will be described below, and refreshing mechanisms, can be employed.

The FBUS interface 28 supports Transmit and Receive flags for each port that a MAC device supports, along with an Interrupt flag indicating when service is warranted. The FBUS interface 28 also includes a controller 28a that performs header processing of incoming packets from the FBUS 18. The controller 28a extracts the packet headers and performs a micro programmable source/destination/protocol hashed lookup (used for address smoothing) in SRAM 16b. If the hash does not successfully resolve, the packet header is sent to the processor core 20 for additional processing. The FBUS interface 28 supports the following internal data transactions:

| | | |
|---|---|---|
| FBUS unit | (Shared bus SRAM) | to/from micro |
| | | engine. |
| FBUS unit | (via private bus) | writes from SDRAM |
| | | Unit. |
| FBUS unit | (via Mbus) | Reads to SDRAM. |

The FBUS 18 is a standard industry bus and includes a data bus, e.g., 64 bits wide and sideband control for address and read/write control. The FBUS interface 28 provides the ability to input large amounts of data using a series of input and output FIFOs 29a-29b. From the FIFOs 29a-29b, the micro engines 22a-22f fetch data from or command the SDRAM controller 26a to move data from a receive FIFO in which data has come from a device on bus 18, into the FBUS interface 28. The data can be sent through memory controller 26a to SDRAM memory 16a, via a direct memory access. Similarly, the micro engines can move data from the SDRAM 26a to interface 28, out to FBUS 18, via the FBUS interface 28.

Data functions are distributed amongst the micro engines 22. Connectivity to the SRAM 26a, SDRAM 26b and FBUS 28 is via command requests. A command request can be a memory request or a FBUS request. For example, a command request can move data from a register located in a micro engine 22a to a shared resource, e.g., an SDRAM location, SRAM location, flash memory or some MAC address. The commands are sent out to each of the functional units and the shared resources. However, the shared resources do not need to maintain local buffering of the data. Rather, the shared resources access distributed data located inside of the micro engines 22a-22f. This enables micro engines 22a-22f , to have local access to data rather than arbitrating for access on a bus and risk contention for the bus. With this feature, there is a zero cycle stall for waiting for data internal to the micro engines 22a-22f.

The data buses, e.g., ASB bus 30, SRAM bus 34 and SDRAM bus 38 coupling these shared resources, e.g., memory controllers 26a and 26b, are of sufficient bandwidth such that there are no internal bottlenecks. In order to avoid bottlenecks, the processor 12 has an bandwidth requirement where each of the functional units is provided with at least twice the maximum bandwidth of the internal buses. As an example, the SDRAM 16a can run a 64 bit wide bus at 83 MHz. The SRAM data bus could have separate read and write buses, e.g., could be a read bus of 32 bits wide running at 166 MHz and a write bus of 32 bits wide at 166 MHz. That is, in essence, 64 bits running at 166 MHz that is effectively twice the bandwidth of the SDRAM.

The core processor 20 also can access the shared resources. The core processor 20 has a direct communication to the SDRAM controller 26a to the bus interface 24 and to SRAM controller 26b via bus 32. However, to access the micro engines 22a-22f and transfer registers located at any of the micro engines 22a-22f, the core processor 20 access the micro engines 22a-22f via the ASB Translator 30 over bus 34. The ASB translator 30 can physically reside in the FBUS interface 28, but logically is distinct. The ASB Translator 30 performs an address translation between FBUS micro engine transfer register locations and core processor addresses (i.e., ASB bus) so that the core processor 20 can access registers belonging to the micro engines 22a-22f.

Although micro engines 22a-22f can use the register set to exchange data as described below, a scratchpad memory 27 is also provided to permit micro engines 22a-22f to write data out to the memory for other micro engines to read. The scratchpad 27 is coupled to bus 34.

The processor core 20 includes a RISC core 50 implemented in a five stage pipeline performing a single cycle shift of one operand or two operands in a single cycle, provides multiplication support and 32 bit barrel shift support. This RISC core 50 is a standard Strong Arm® architecture but it is implemented with a five-stage pipeline for performance reasons. The processor core 20 also includes a 16-kilobyte instruction cache 52, an 8-kilobyte data cache 54 and a prefetch stream buffer 56. The core processor 20 performs arithmetic operations in parallel with memory writes and instruction fetches. The core processor 20 interfaces with other functional units via the ARM defined ASB bus. The ASB bus is a 32-bit bi-directional bus 32.

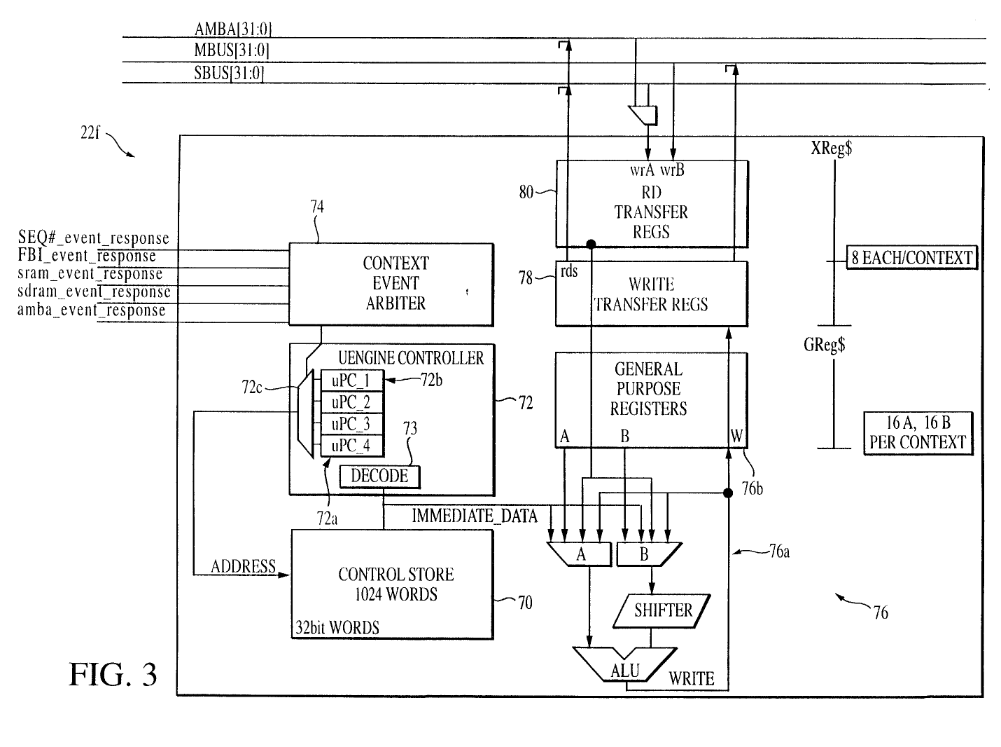

Referring to FIG. 3, an exemplary one of the micro engines 22a-22f, e.g., micro engine 22f, is shown. The micro engine 22f includes a control store 70, which, in one implementation, includes a RAM of here 1,024 words of 32 bit. The RAM stores a micro program (not shown). The micro program is loadable by the core processor 20. The micro engine 22f also includes controller logic 72. The controller logic 72 includes an instruction decoder 73 and program counter (PC) units 72a-72d. The four micro program counters 72a-72d are maintained in hardware. The micro engine 22f also includes context event switching logic 74. Context event logic 74 receives messages (e.g., SEQ_#_EVENT_RESPONSE; FBI_EVENT_RESPONSE; SRAM_EVENT_RESPONSE; SDRAM _EVENT_RESPONSE; and ASB_EVENT_RESPONSE) from each one of the shared resources, e.g., SRAM 26a, SDRAM 26b, or processor core 20, control and status registers, and so forth. These messages provide information on whether a requested function has completed. Based on whether or not a function requested by a thread has completed and signaled completion, the thread needs to wait for that completion signal, and if the thread is enabled to operate, then the thread is placed on an available thread list (not shown). The micro engine 22f can have a maximum of four threads available.

In addition to event signals that are local to an executing thread, the micro engines 22a-22f employ signaling states that are global. With signaling states, an executing thread can broadcast a signal state to all micro engines 22a-22f, e.g., Receive Request Available (RRA) signal, any and all threads in the micro engines 22a-22f can branch on these signaling states. These signaling states can be used to determine availability of a resource or whether a resource is due for servicing.

The context event logic 74 has arbitration for the four threads. In an embodiment, the arbitration is a round robin mechanism. Other techniques could be used including priority queuing or weighted fair queuing. The micro engine 22f also includes an execution box (EBOX) data path 76 that includes an arithmetic logic unit (ALU) 76a and general-purpose register set 76b. The ALU 76a performs arithmetic and logical functions as well as shift functions. The register set 76b has a relatively large number of general-purpose registers. In an embodiment, there are 64 general-purpose registers in a first bank, Bank A and 64 in a second bank, Bank B. The general-purpose registers are windowed so that they are relatively and absolutely addressable.

The EBOX also includes two input multiplexors, “mux A” and “mux B”, which provide a selection capability of the operands to be input to ALU 76a. The 32-bit wide output buses from several microengine data sources are connected to mux A and mux B, including an IMMEDIATE_DATA bus from the control logic 72, a write-back data bypass bus from the output of ALU 76a, and a data bus from read register bank 80. Also, an output bus from Bank A of general-purpose register 76b is connected to input mux A and an output bus from Bank B of general-purpose register 76b is connected to input mux B. All of the bus inputs to mux A and mux B are 32 bits wide. Control logic is provided to mux A and mux B to allow selection of individual 8-bit bytes of each operand transferred through to ALU 76a, as explained below in reference to local register instructions.

The micro engine 22f also includes a write transfer register stack 78 and a read transfer stack 80. These registers 78 and 80 are also windowed so that they are relatively and absolutely addressable. Write transfer register stack 78 is where write data to a resource is located. Similarly, read register stack 80 is for return data from a shared resource. Subsequent to or concurrent with data arrival, an event signal from the respective shared resource e.g., the SRAM controller 26a, SDRAM controller 26b or core processor 20 will be provided to context event arbiter 74, which will then alert the thread that the data is available or has been sent. Both transfer register banks 78 and 80 are connected to the execution box (EBOX) 76 through a data path. In an embodiment, the read transfer register has 64 registers and the write transfer register has 64 registers.

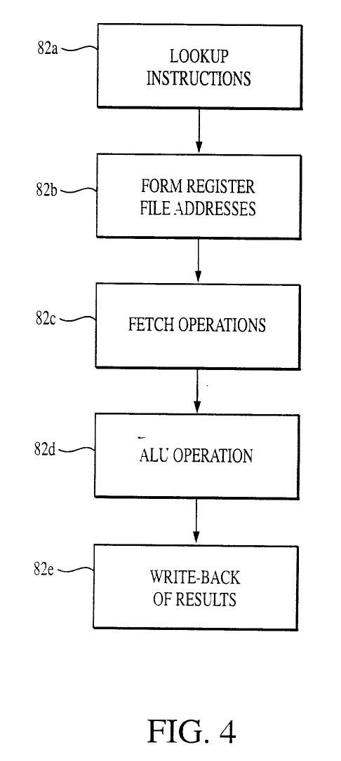

Referring to FIG. 4, the micro engine data path maintains a 5-stage micro-pipeline 82. This pipeline includes lookup of microinstruction words 82a, formation of the register file addresses 82b, read of operands from register file 82c, ALU shift or compare operations 82d, and write-back of results to registers 82e. By providing a write-back data bypass into the ALU/shifter units, and by assuming the registers are implemented as a register file (rather than a RAM), the micro engine 22f can perform a simultaneous register file read and write, which completely hides the write operation.

The SDRAM interface 26aprovides a signal back to the requesting micro engine on reads that indicates whether a parity error occurred on the read request. The micro engine micro code is responsible for checking the SDRAM 16a read Parity flag when the micro engine uses any return data. Upon checking the flag, if it was set, the act of branching on it clears it. The Parity flag is only sent when the SDRAM 16a is enabled for checking, and the SDRAM 16a is parity protected. The micro engines 22 and the PCI Unit 14 are the only requestors notified of parity errors. Therefore, if the processor core 20 or FIFO 18 requires parity protection, a micro engine assists in the request. The micro engines 22a-22f support conditional branches.

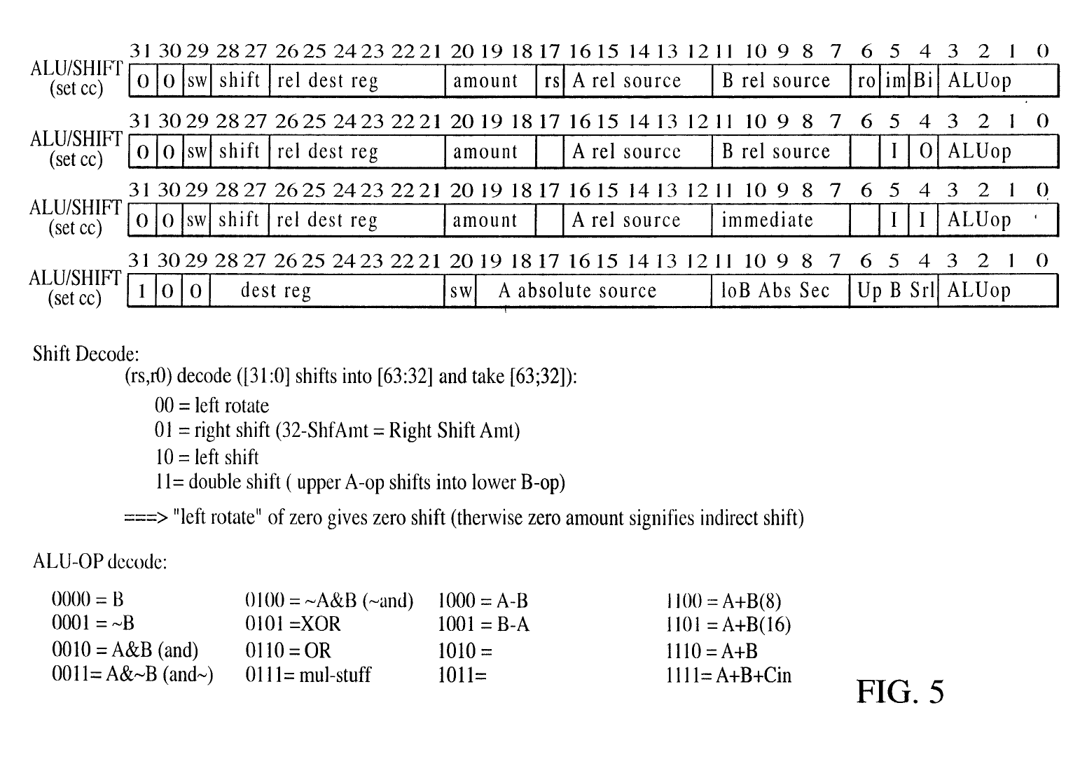

Referring to FIG. 5, a format for an arithmetic logic unit instruction is shown. The micro engines 22 support instructions contained within an instruction set. The instruction set includes logical and arithmetic operations that perform an ALU operation on one or two operands and deposit the result into the destination register, and update all ALU condition codes according to the result of the operation. Condition codes are lost during context swaps.

The computer instruction set also includes local register instructions. Specifically, the LD_FIELD and LD_FIELD_W_CLR instructions provide a means for changing one or individual bytes without changing other bytes by super-imposing the change on one local register in one instruction. More specifically, the LD_FIELD and LD_FIELD_W_CLR instructions load one or more bytes within a local register with the shifted value of another operand. Data in the bytes that are not loaded remain unchanged or are cleared. LD_FIELD performs a read-modify-write on a read transfer register. LD_FIELD_W_CLR performs a write to a write transfer register. LOAD_CC loads all ALU codes based on the result formed.

A low field instruction format is:

ld_field[dest_reg, byte_ld_enables, source_op, opt_shf_cntl], optional_token

A low field with clear instruction format is:

ld_field_w_clr[dest_reg, byte_ld_enables, source_op, opt_shf_cntl], optional_token

A description of each of the field is described below.

The “dest_reg” field represents an absolute or context-relative transfer register or general-purpose register (GPR) that holds the result of the instruction. The “byte_ld_enables” field represents a 4-bit mask that specifies which byte(s) are affected by the instruction. Each set bit enables the corresponding byte of the destination operand longword to be loaded or cleared. There must be at least 1 set bit in this mask. For example, 0101 loads the 1st and 3rd bytes while the other bytes remain unchanged.

The “source_op” field represents a context relative register name. This register must be on the opposite bank as the destination register. The “opt_shf_cntl” field represents shift or rotate the register contents using a syntax shown as follows:

| Operation | Description |
|---|---|
| <<n | Left shift n bits, where n = |
| | 1 through 31. |
| <<indirect | Left shift by an amount |
| | specified in the lower 5 bits of |
| | the A operand of the previous |
| | instruction. The lower 5 bits of the A |
| | operand should be (32-n), where n is the |
| | desired left shift amount. |
| >>n | Right shift n bits, where n = |
| | 1 through 31. |
| >>indirect | Right shift by the amount |
| | specified in the lower 5 bits of |
| | the A operand of the previous |
| | instruction. |
| <<rot n | Left rotate n bits,where n = |
| | 1 through 31. |
| >>rot n | Right rotate n bits, where |
| | n = 1 through 31. |

A programmer may supply an optional field referred to as “optional_token.” When the optional_token field contains a “load_cc” parameter, ALU condition codes are loaded based on the result formed.

For example, if dest_op=0×AABBCCDD and src_op=0×11223344, then ld_field[dest_op, 0101, src_op, <<rot 4] results in dest_op−AA23CC41.

In another example, ld_field[dest_reg, byte_ld_enables, source_reg, shift_cntl], load_cc allows a source register to be shifted, and then some byte-aligned portion(s) of the shifted data be loaded into the destination register.

The same options exist for the shift_cntl operand as do with the alu shf_opcode with the following exceptions: 1) a shift amount of zero is permitted, 2) if immediate data is used instead of a source register, then only left shifts or rotates in multiples of 8 bits are allowed.

The byte_ld_enables field consists of 4 bits; each set bit enables corresponding byte of the destination longword to be loaded by the corresponding bits of the shifted source operand. Also note that the load_cc token was added in this case to specify that this microword will set the ALU condition codes. Note that a comma is appended to the end of the opcode token that indicates to the assembler that the following token is part of the same microword. In general, a microword consists of 1 opcode token following by 0 or more qualifying tokens, all of which end with a comma except for the final token. In other words, the absence of a comma after a token designates the end of one microword and the beginning of another. Also note tokens of the same microword can appear on multiple lines. In this example, the following token, load_cc indicates that the ALU condition codes should be set based on the ALU result.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A processor, comprises:
an execution unit for executing multiple context threads, said execution unit comprises:
an arithmetic logic unit to process operands for executing threads;
a multiplexor;
control logic to control the operation of the arithmetic logic unit and the multiplexor;
an immediate data bus coupled from the output of the control logic to an input of the multiplexor to provide immediate data to the arithmetic logic unit through the multiplexor;
a general purpose register coupled to the input of the multiplexor to provide register operand data to the arithmetic logic unit through the multiplexor; and
a read transfer register coupled to the input of the multiplexor to provide operand data from a memory device;
wherein execution of a register instruction causes data from one or more input sources connected to the multiplexor to be transferred through the multiplexor into the arithmetic logic unit and causes data to be transferred through the arithmetic logic unit to one of the registers.

2. The execution unit of claim I wherein the register instruction includes a bit mask specifying which one or more bytes are affected and causing the bytes specified by the bit mask to be loaded from the immediate data bus and the bytes not specified to be loaded from the read transfer register.

3. The execution unit of claim 1 wherein the register instruction includes a bit mask specifying which one or more bytes are affected and causing the bytes specified by the bit mask to be loaded from the immediate data bus and the bytes not specified to be loaded from the general purpose register.

4. The execution unit of claim 1 further comprising: a bypass bus coupled from the output of the arithmetic logic unit to an input of the multiplexor; and
control logic to control the execution of a series of pipelined instructions wherein each pipelined instruction may specify a read part and a write part, where the read part of one pipelined instruction specifies a read address that is the same as a write address of the write part of another pipelined instruction causing the data being written by the write part to be available to the read part in the same processor cycle.

5. A method for executing multiple context threads comprises:
processing operands for an executing thread through a multiplexor and an arithmetic logic unit;
operating control logic connected to the arithmetic logic unit and the multiplexor;
providing immediate data on an immediate data bus coupled from the output of the control logic to an input of the multiplexor;
providing operand data to the arithmetic logic unit from a general purpose register coupled to the input of the multiplexor;
providing operand data from a memory device through a read transfer register coupled to the input of the multiplexor; and
executing a register instruction to cause data from one or more input sources connected to the multiplexor to be transferred through the multiplexor into the arithmetic logic unit and to cause data to be transferred through the arithmetic logic unit to one of the registers.

6. The method of claim 5 wherein executing a register instruction further comprises:
including a bit mask; and
causing the bytes specified by the bit mask to be transferred through the multiplexor from the immediate data bus and the bytes not specified to be transferred through the multiplexor from the transfer register.

7. The method of claim 5 wherein executing a register instruction further comprises:
including a bit mask; and
causing the bytes specified by the bit mask to be transferred through the multiplexor from the immediate data bus and the bytes not specified to be transferred through the multiplexor from the general purpose register.

8. A computer program product residing on a computer readable medium causing a processor to perform a function comprises instructions causing the processor to:
perform a register operation which specifies a bit mask corresponding to one or more bytes of data to cause the bytes specified by the bit mask to be loaded from an immediate data bus and the bytes not specified to be loaded from a register data bus.
